(19) United States
(12) Patent Application Publication
(10) Pub. No.: US 2017/0343043 A1
(43) Pub. Date: Nov. 30, 2017

(54) Radial-loading Magnetic Reluctance Device

(71) Applicant: Raymond James Walsh, Dallas, TX (US)

(72) Inventor: Raymond James Walsh, Dallas, TX (US)

(21) Appl. No.: 14/710,429

(22) Filed: May 12, 2015

Related U.S. Application Data
(60) Provisional application No. 61/991,642, filed on May 12, 2014.

(51) Int. Cl. F16C 32/04

(52) U.S. Cl. CPC F16C 32/0425; F16C 32/0431

(57) ABSTRACT

A magnetic bearing retains a rotatable shaft in a selected position by magnetic coupling between two circularmagnetic assemblies, one of which is connected to the shaft. Each magnetic coupling completes a magnetic circuit. Shaft rotation does not affect the magnetic circuit, but radial displacement of the shaft disrupts the magnetic circuit and increases magnetic reluctance. Increasing magnetic reluctance inhibits radial displacement. The shaft thereby supports a load while rotating freely, constrained to a selected position by forces of magnetic reluctance. A bearing may be employed to maintain gap distance between the magnetic assemblies.

### PRIORITY/CROSS-REFERENCE TO RELATED APPLICATIONS

This application claims the benefit of U.S. Provisional Application No. 61/991,642, filed May 12, 2014, the disclosure of which is incorporated by reference.

### TECHNICAL FIELD

The disclosed technology generally relates to bearings, and more particularly to magnetic bearings.

### BACKGROUND

A bearing is a machine element that both reduces friction and constrains motion between moving parts. Many types of bearings exist, but the greatest reduction in friction occurs when a magnetic bearing is employed, which supports a load using magnetic levitation. Magnetic bearings permit relative motion with very low friction and mechanical wear, and thus support the highest speeds of all kinds of bearing.

Some magnetic bearings use permanent magnets and do not require input of power, but do require external stabilization due to the limitations described by Earnshaw's Theorem. Most magnetic bearings use attraction or repulsion to achieve levitation. Review of the prior art, however, indicates that magnetic bearings exploiting magnetic reluctance have not previously been described.

Magnetic reluctance is defined as the resistance to the flow of magnetic flux through a magnetic circuit as determined by the magnetic permeability and arrangement of the materials of the circuit. Magnetic permeability can be thought of as the ability of a material to allow passage of magnetic flux. It is analogous to the concept of conductivity in electricity. Iron, for instance, has a high magnetic permeability whereas air has low magnetic permeability. Magnetic flux will pass through air, just as an electric spark will cross an air gap, but flux passes much more readily through iron. The components comprising a magnetic circuit tend to act in such a way as to facilitate the flow of magnetic flux through the circuit, and thus minimize reluctance.

Reluctance is said to be at a minimum when a magnetic circuit employs materials with the greatest permeability and when the path of the magnetic flux completes the magnetic circuit by the most direct route possible. Reducing air gaps between the magnets and/or ferromagnetic components minimizes reluctance; conversely, reluctance increases whenever a magnetic circuit is disrupted by an increased air gap between the magnetic materials comprising the circuit. Air, having relatively low magnetic permeability, resists the flow of magnetic flux. Directing or focusing the path of flux between the magnetic elements by use of magnet arrays such as the Halbach series facilitates completion of a magnetic circuit and minimizes reluctance.

This principle is most famously illustrated in Tesla's Switched Reluctance Motor. A ferromagnetic rotor is made to rotate between electromagnets of opposite polarity (stator coils). The rotor is compelled to rotate in order to complete a magnetic circuit through the rotor and stator coils. At the point in the rotation where magnetic flux flows most readily, the magnetic circuit is said to be in a state of minimal reluctance. A series of stator coils are configured in a circle, directing magnetic flux inward towards the ferromagnetic rotor. Successively switching the polarity of the stator coils just ahead of the rotating rotor enables continued rotation. Although the Switched Reluctance Motor employs electromagnets, the reluctance principle also applies to magnetic circuits comprising permanent magnets.

Consider the example of two Halbach arrays magnetically coupled. Recall that a Halbach array, in its simplest form, comprises five magnets configure to substantially direct magnetic flux from one side of the array. The north magnetic pole and the south magnetic pole extend from the same side of the array substantially parallel to one another. When two Halbach arrays couple magnetically, a magnetic circuit is formed. A force is required to displace one array laterally relative to the other. This is known as increasing magnetic reluctance. Replacing the arrays to their preferred position reduces magnetic reluctance by allowing magnetic flux to flow by the most direct route.

Magnetic reluctance has different and advantageous physical and mathematical properties in comparison to the typical magnetic forces of magnetic attraction and repulsion. Whereas the force between magnets falls off with the inverse of the square of the distance between the magnets, reluctance forces increase in a linear fashion with displacement. For example, when two Halbach series are magnetically coupled across an air gap of distance X, the force between the arrays is only ¼ as strong at a gap distance of 2X. Experimentation has shown that when two arrays are made to slide past each other at a constant gap distance X, like railway cars on parallel tracks moving in opposite directions, reluctance forces will increase in linear fashion over a short displacement, achieve a maximum, then fall to zero in linear fashion. By way of reference, both a rubber band and a steel spring demonstrate linear force-displacement characteristics. Pulling on either is initially easy but becomes harder the more the rubber band or spring is stretched up to the point of failure

### SUMMARY OF THE DISCLOSURE

The purpose of the summary is to enable the public, and especially scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

A reluctance magnetic bearing employs magnetic reluctance to achieve magnetic levitation. Once a magnetic circuit has formed between magnets and/or circular magnet s within the bearing, there is a propensity to maintain the magnetic circuit. An outside force that disrupts this magnetic circuit increases reluctance and produces an equal and opposite force within the bearing assembly in an attempt to return to a state of minimal reluctance. An axial load may be substantially supported without physical contact between bearing surfaces, thus minimizing friction.

The present embodiment relates to a magnetic bearing in which an axle or shaft held in place and allowed to rotate by means of magnetic coupling between at least two magnetic assemblies, with at least one of them being circular in shape. One of the assemblies is attached to the shaft while the other is fixed. The assemblies face each other across a gap. The magnetic coupling completes a magnetic circuit, and this circuit is maintained even while one assembly rotates relative to the other. Once the magnetic circuit is formed, magnetic reluctance prevents radial displacement of the shaft but allows free rotation. There is no physical contact across the gap, thus reducing friction while constraining motion between moving parts. A secondary bearing maintains gap distance.

One preferred embodiment employs a first magnetic assembly made of two axially-magnetized ring magnets of equal thickness, one having a smaller radius than the other so that the smaller fits within the larger. The magnetic polarities are oriented opposite one another. This magnet-within-a-magnet arrangement is magnetically coupled to a flat iron ring adjacent to one side allowing flux from the outer magnet to flow through the iron ring and into the inner magnet. On the side opposite side of the iron ring, the outer magnet serves as a circular-shaped south magnetic pole and the inner magnet a circular-shaped north magnetic pole. This first magnetic assembly is coupled to a second magnetic assembly, identical to the first but configured with the outer ring magnet serving as a circular-shaped north magnetic pole and the inner magnet a circular-shaped south magnetic pole. The first magnetic assembly may be attached to a shaft or axle while the second is fixed, and the shaft may be attached to a flywheel.

The rotating shaft is generally an elongate rod that has a linear axis and is configured for rotation around the linear axis, but may also take the form of a cylinder. The linear axis is called the rotational axis. Whether shaft or cylinder, both forms will be referred to as a shaft in this description. The shaft can be a solid rod, or a hollow tube.

Since the magnetic assemblies are attracted to one another across the gap, a secondary bearing may be needed to maintain the gap distance. This secondary bearing may be of any sort, including magnetic or mechanical, and may be a source of friction when the secondary bearing is mechanical. The degree of friction will depend in part on the force required to maintain the gap.

A traction force between the assemblies may be offset by a weight. In one preferred embodiment, a first assembly is fixed while a second assembly is attached to a shaft attached to a flywheel. Gravitational force on the flywheel serves as a significant counter-traction to the force of attraction between the magnetic assemblies. Limitations implied by Earnshaw's Theorem prevents exact balancing between these two forces, but the forces may be balanced closely. The magnetic force must slightly exceed the gravitational force in order to keep the magnetic assemblies engaged. A secondary bearing maintains the gap distance. The size of the secondary bearing is determined by how closely the magnetic and gravitation forces are balanced, and small secondary bearing with commensurately small friction may be sufficient. In this way, a heavy flywheel may be rotated at high speed with minimal friction.

The goal of free rotation may be achieved if only one of the magnetic assemblies is circular. A second complimentary assembly need not be circular; it may comprise a plurality of Halbach arrays, for instance, each magnetically coupled to the circular assembly and arranged symmetrically and extending radially from the axis of rotation in state of minimal reluctance. As described above, the circular magnetic assemblies have both north and south magnetic poles extending from one side. Likewise, a typical Halbach array comprising five magnets focuses both north and south magnetic flux from one side of the array. A magnetic circuit is formed when the north and south poles of an individual Halbach array couple magnetically with the ring-shaped north and south poles of a magnet assembly. Two or more Halbach arrays coupled in this way and arranged symmetrically would constrain axial displacement of the ring-shaped magnet assembly while allowing rotation of the assembly relative to the Halbach arrays.

The function of the magnetic assemblies may be enhanced by iron or ferromagnetic flux-focusing elements attached to the magnetic poles of the circular magnetic assemblies and/or the magnet arrays.

In the same vein as a Halbach array, an array of three consecutive magnets can effectively focus magnetic flux so that north and south poles extend parallel to each other from the same side of the array. These three magnets are configured in linear fashion such that the center magnet is rotated 90 degrees relative to the end magnets, and the end magnets are rotated 180 degrees relative to each other. This type of magnet array will be called a reluctance array. Like the Halbach series, the north and south magnetic poles emanate from one side of the reluctance array.

The magnet arrays may be attached to a rotatable shaft or cylinder while the circular magnet assembly is fixed, or the circular magnet assembly may be attached to a rotatable shaft or cylinder while the magnet arrays are fixed. Either way, the goal is axial rotation of the circular magnet assembly relative to the magnet arrays.

Each individual magnet array completes a magnetic circuit by coupling with the circular magnet assembly. The circular magnetic assembly has an axis of rotation about a central position. When attached to a shaft, a radial load placed on the shaft will displace the circular magnet assembly away from this center position, disrupting the magnetic circuits between the magnet arrays and the circular magnet. Disruption of these magnetic circuits increases reluctance, causing an equal and opposite radial force to be produced by the magnetic bearing. In this way, the radial load is magnetically levitated, and the shaft is restricted in its ability to move in an radial direction.

The radial loading magnetic bearing force-displacement curve is initially quite linear up to the capacity of the bearing. This allows the bearing to accommodate a variable load, fluctuating load, or even a vibrating load. This is analogous to the action of an automobile shock absorber as the vehicle travels uneven terrain. Because the force-displacement curve is linear and reproducible, the device can also be graduated and calibrated to function as a weight scale, analogous to a spring scale.

### BRIEF DESCRIPTION OF PREFERRED EMBODIMENTS

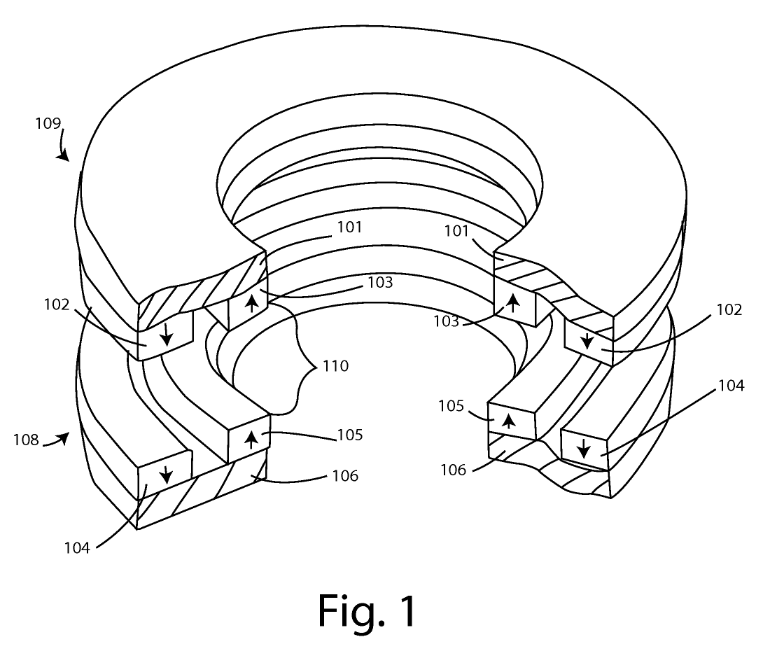

FIG. 1 is a perspective view of one embodiment a magnetic bearing.

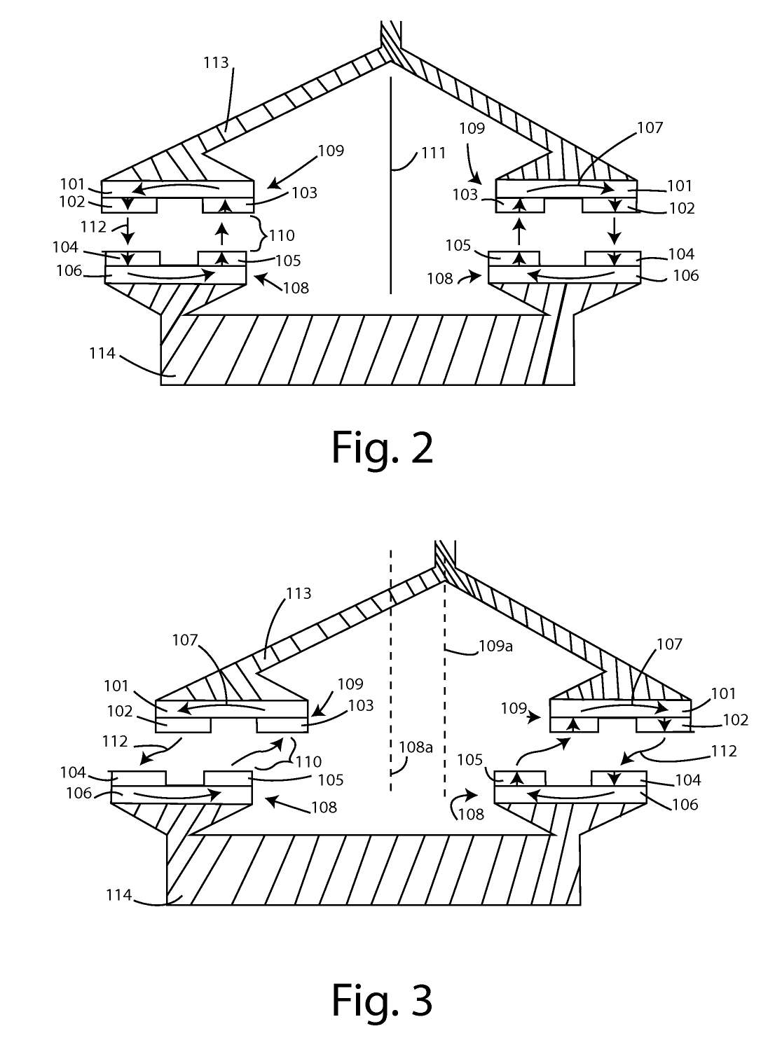

FIG. 2 is a side view schematic of a magnetic bearing in a state of minimal reluctance.

FIG. 3 is a side view schematic of the same magnetic bearing but in a position of increased reluctance.

### DETAILED DESCRIPTION OF A PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concepts) is to cover all modifications, alternative constructions, and equivalents falling within the spirit and scope of the inventive concept(s) as defined in the claims.

In order that the invention may be more fully understood, it will now be described by way of example, with reference to the accompanying drawings. Magnetic field line arrows may be depicted as flowing from the north pole to the south pole.

FIG. 1 is a perspective view of circular magnetic assemblies 108 and 109 separated by gap 110. Outer circular magnet 102 is magnetized axially with magnetic north pointing downward, while inner circular magnet 103 is magnetized axially with magnetic north pointing upward. Circular magnets 102 and 103 are magnetically coupled to circular ferromagnetic element 101.

Likewise, outer circular magnet 104 is magnetized axially with magnetic north pointing downward, while inner circular magnet 105 is magnetized axially with magnetic north pointing upward. Circular magnets 104 and 105 are magnetically coupled to circular ferromagnetic element 106 which serves as a conduit of magnetic flux.

Directing or focusing the path of flux between the magnetic assemblies 108 and 109 facilitates completion of a magnetic circuit and minimizes reluctance. The circular magnetic assemblies 108 and 109 in this embodiment focus magnetic flux so that north and south poles extend parallel to each other from the same side of the each magnetic assembly like a Halbach series.

FIGS. 2 and 3 are both side view schematics that illustrate the distortion of magnetic circuits within the embodiment with axial displacement of circular magnetic assembly 108 relative to circular magnetic assembly 109. The role of the magnet assemblies 108 and 109 is to focus magnetic field lines 112 so as to complete magnetic circuits by the most direct and magnetically permeable route. This implies minimizing air gap 110 between magnetic assemblies, and employment of magnetically permeable ferromagnetic materials. The construction of ferromagnetic rings 101 and 106 allows flux 107 flow between inner ring 103 and outer magnetic ring 102. Once formed, the complete magnetic circuit allows forces of magnetic reluctance to come into play. These reluctance forces constrain shaft assembly 113 to rotate about axis 111 while base assembly 114 remains in a fixed position.

In FIG. 2, the axis of rotation of magnetic assembly 109 is denoted 111. Axis 111 is also the center axis for magnetic assembly 108. In a state of minimal reluctance, and when no radial load is present, circular magnetic assemblies 108 and 109 share axis 111.

In FIG. 3, however, the axis of rotation 109a of magnetic assembly 109 has shifted laterally from axis of rotation 108a of magnetic assembly 108. This occurs when magnetic assembly 109 experiences a lateral mechanical load relative to magnetic assembly 108. Lateral displacement also increases distance between circular magnet 102 and circular magnet 104, as well as circular magnet 103 and circular magnet 105. This results in an elongation of magnetic field lines 112, and therefore increased reluctance. The increased reluctance produces a force equal and opposite the force imposed by the load. Means (not shown) are required to maintain the gap 110, such means including a secondary rolling bearing, a magnetic bearing, or a plain bearing.

One might conceive of embodiments in which magnetic assembly 108 or 109 is replaced by an assembly comprising a plurality of 5-magnet Halbach arrays or reluctance arrays. As long as one magnetic assembly is circular in design relative motion is constrained by the forces of reluctance, and the capacity for free and unrestricted rotation is preserved even when the complimentary assembly comprises a series of individually coupled magnetic arrays.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. A magnetic bearing for a rotating shaft, comprising:
a generally elongate shaft with a linear axis and configured for rotation around said linear axis with said shaft held within a predetermined position on said linear axis by magnetic forces;
a first circular magnetic assembly operationally connected to said shaft comprised of a first outer circular magnet and a first inner circular magnet, and further comprising a first circular ferromagnetic element magnetically coupled to said first outer circular magnet and said first inner circular magnet;
a second circular magnetic assembly attached to a base comprised of a second outer circular magnet and a second inner circular magnet, and further comprising a second circular ferromagnetic element magnetically coupled to said second outer circular magnet and said second inner circular magnet;
said circular magnetic assembly being magnetically coupled to said second magnetic assembly so as to complete a magnetic circuit;
wherein said shaft is substantially held in a preselected position by reluctance magnetic forces between said first circular magnetic assembly and said second magnetic assembly.

2. The magnetic bearing of claim 1 further comprising a bearing for maintaining a gap between the first circular magnetic assembly and the second magnetic assembly.
